(19) United States
(12) Patent Application Publication
(10) Pub. No.: US 2017/0276334 A1
(43) Pub. Date: Sep. 28, 2017

(54) LIGHTING FIXTURE FOR DROP CEILINGS

(71) Applicants: George Erik McMillan, Hickory, NC (US); Peter James Lohr, Morganton, NC (US)

(72) Inventors: George Erik McMillan, Hickory, NC (US); Peter James Lohr, Morganton, NC (US)

(21) Appl. No.: 15/487,319

(22) Filed: Apr. 13, 2017

Related U.S. Application Data
(63) Continuation-in-part of application No. 15/467,712, filed on Mar. 23, 2017.
(60) Provisional application No. 62/321,847, filed on Apr. 13, 2016.
(60) Provisional application No. 62/312,101, filed on Mar. 23, 2016.

(51) Int. Cl. F21V 21/04; F21V 23/06; F21S 8/02

(52) U.S. Cl. CPC F21V 21/041; F21S 8/026; F21V 23/06

(57) ABSTRACT

Disclosed is a light fixture configured to be mounted on a drop ceiling. The light fixture includes a luminaire. The luminaire includes a body comprising a cavity configured to house one or more light sources. Further, the luminaire includes a bezel circumferentially disposed around an opening of the cavity. Yet further, the luminaire includes an electrical connector configured to interface with a power cable. Moreover, the luminaire includes multiple fastening members configured to fasten the bezel to a drop-ceiling tile.

The current application claims a priority to the U.S. Provisional Patent application Ser. No. 62/321,847 filed on Apr. 13, 2016.

### FIELD OF THE INVENTION

The present disclosure generally relates to light fixtures. More specifically, the present disclosure relates to light fixture configured to be mounted to a drop ceiling.

### BACKGROUND OF THE INVENTION

Many commercial and residential buildings have drop ceilings. National Electrical Code (NEC) and many other standard organizations provide guidelines for incorporating light fixtures (luminaires) into drop ceilings. For example, for safety reasons when installing recessed can-type lighting, the guidelines recommend that a complete recessed light fixture must be safely attached above the drop ceiling and secured to the actual ceiling above drop ceiling structure. If the recessed light fixture is not attached to the actual ceiling structure, the weight of the recessed light fixture may cause the ceiling tiles to warp over time which may pose a safety hazard. The tile may be warped to a point where the recessed light fixture falls. Therefore, it is prescribed procedure to mount the recessed light fixture includes attaching it to the actual ceiling structure above the drop ceiling.

However, the prescribed procedure is labor intensive and complex as calculations must be made in order to place the light at a desired location. Further, if there is no adequate structural attachment point is available, it makes mounting the light fixture very difficult. It is also expensive to purchase the proper structural housings to be utilized.

Accordingly, there is a need for a light fixture that can be safely mounted directly to the drop ceiling tile.

### SUMMARY

Disclosed is a light fixture configured to be mounted on a drop ceiling. The light fixture includes a luminaire. The luminaire includes a body comprising a cavity configured to house one or more light sources. Further, the luminaire includes a bezel circumferentially disposed around an opening of the cavity. Yet further, the luminaire includes an electrical connector configured to interface with a power cable. Moreover, the light fixture includes multiple fastening members configured to fasten the bezel to a drop-ceiling tile.

According to some aspects, a light fixture configured to be mounted on a drop-ceiling is disclosed. The light fixture includes a luminaire. The luminaire includes a body comprising a cavity and an opening leading to the cavity. Further, the luminaire includes a socket attached to the body, wherein the socket is configured to receive a light source. Yet further, the luminaire includes an electrical connector configured to interface with a power cable, wherein the electrical connector is electrically coupled to the socket in order to provide electrical power to the one or more light sources. Moreover, the luminaire includes a collar plate disposed at a periphery of the opening, wherein the collar plate comprises an upper side, a lower side and an exterior side, wherein the collar plate extends lateral to a longitudinal axis of the body, wherein the collar plate comprises multiple openings configured to receive a fastening member. Further, the luminaire includes multiple fastening members comprising a set of upper fastening members and a set of lower fastening members, wherein the set of upper fastening members are configured to fasten the collar plate to a bottom surface of a drop-ceiling tile through the multiple openings, wherein the upper fastening members are configured to be disposed over the upper side of the drop-ceiling, wherein the upper fastening members are configured to mechanically engage with the lower set of fastening members, wherein at least one of the upper set of fastening members and the lower set of fastening members comprise a multiple protrusions configured to be lodged into at least one of the top surface of the drop-ceiling tile and the bottom surface of the drop-ceiling tile.

According to some aspects, a retrofit kit for facilitating mounting of a recessed light fixture to a drop-ceiling is disclosed. The retrofit kit includes a collar plate comprising an upper side, a lower side, an interior side and an exterior side, wherein the interior side is configured to be juxtaposed with an exterior surface of a body of the recessed light fixture, wherein the exterior surface is proximal to a light fixture opening of the recessed light fixture, wherein the collar plate comprises a collar plate opening conforming to the light fixture opening, wherein the collar plate further comprises a multiple holes, wherein each hole is configured to receive a fastening member configured to fasten the collar plate to a drop-ceiling tile. Further, the retrofit kit includes one or more collar plate fasteners configured to fasten the collar plate to the body of the recessed light fixture. Yet further, the retrofit kit includes multiple drop-ceiling fasteners configured to fasten the collar plate to the drop-ceiling tile, wherein the multiple drop-ceiling fasteners comprises a set of upper fastening members and a set of lower fastening members, wherein the set of upper fastening members are configured to fasten the collar plate to a bottom surface of a drop-ceiling tile through the multiple holes, wherein the upper fastening members are configured to be disposed over the top surface of the drop-ceiling, wherein the upper fastening members are configured to mechanically engage with the lower set of fastening members, wherein the upper set of fastening members comprise a multiple protrusions configured to be lodged into the top surface of the drop-ceiling tile.

According to embodiments, a recessed can-type lighting fixture with a built in electric junction box utilizing a large bezel is disclosed. Multiple ceiling tile nuts may be configured to create a multi-layer strengthening system. The bezel and the ceiling tile nuts may together sandwich the tile. Accordantly, the system may be configured to prevent warping of the ceiling tile. Therefore, the system may strengthen the ceiling tile when joined into a singular unit. The ceiling tile nuts may be configured to bite into the ceiling tile material and prevent rotation. The area each nut occupies may provide proper load distribution as to not rupture the ceiling tile for a very stable mounting system. In addition, a restraint cable may be utilized for safety in the event that the entire tile dislodges from the standard “T” bar ceiling tile retaining matrix.

Further, the size of the bezel and the mounting method may allow the light fixture to be used in any other ceiling application. In a solid ceiling application, the design may allow the light fixture to be mounted in any size cut-out in the tile. If it is desired to replace an existing recessed can-type light, the mounting brackets and can fitting may be removed and, the disclosed recessed light fixture may be used in the cut-out of a 5″, 6″, 7″, 8″ or any size cut-out in between. Therefore, the size of the cut-out does not need to be accurate, or even circular. As long as the main body of the light fixture fits within the cut-out and the bezel covers the cut-out, the disclosed light fixture forms a perfect, one size fits all solution for any existing recessed can-type light of any size.

The disclosed light fixture minimizes the amount of components needed to safely mount the light fixture into a drop ceiling. Further, it saves a lot of labor cost and material cost. Moreover, it allows mounting the light fixture in virtually any section desired within the area of a drop ceiling. For example, the light fixture may reduce the time required to install by 75-80% when compared to traditional fixtures. Further, it provides more mounting possibilities and positions. The light fixture may be installed with less than 4″ of overhead space.

The disclosed light fixture may be directly attached with the drop-ceiling tile. In addition, a short safety cable may attach the light fixture to a support structure associated with the drop-ceiling. The holding of the drop-ceiling tile by the bezel and the nuts may improve stability and strength of the drop-ceiling tile. Further, the disclosed light fixture may strengthen the drop-ceiling tile when attached as a singular unit. The singular unit includes the entire light fixture and drop ceiling tile.

### BRIEF DESCRIPTION OF THE DRAWINGS

FIG. 1 shows a perspective view of a light fixture configured to be mounted on a drop ceiling, in accordance with various embodiments.

FIG. 2 shows a perspective view the light fixture of FIG. 1 mounted on the drop ceiling.

FIG. 3 shows a perspective view of an upper fastening member to secure the light fixture with the drop ceiling, in accordance with various embodiments

FIG. 4 shows a perspective view of the light fixture before it is installed in a drop-ceiling, in accordance with some embodiments.

FIG. 5 shows a perspective view of the light fixture of FIG. 4 during installation in the drop-ceiling.

FIG. 6 shows a perspective view of the light fixture of FIG. 4 after installation in the drop-ceiling.

FIG. 7 shows a side view of the light fixture of FIG. 4 after installation in the drop-ceiling.

### DETAILED DESCRIPTION OF THE INVENTION

All descriptions are for the purpose of showing selected versions of the present invention and are not intended to limit the scope of the present invention.

Non-limiting and non-exhaustive embodiments of the present invention are described with reference to the preceding figures, wherein like reference numerals refer to parts throughout the various views unless otherwise precisely specified.

The present disclosure relates to a light fixture configured to be mounted on a drop ceiling. The light fixture may include a luminaire. The luminaire may be a can-type lighting system. The luminaire may include a body comprising a cavity configured to house one or more light sources. The luminaire may also include a socket configured to receive the one or more light sources.

Further, the luminaire may include a bezel circumferentially disposed around an opening of the cavity. The body may include a proximal portion and a distal portion, wherein the bezel may be disposed adjacent to the proximal portion, wherein the distal portion may be configured to pass through a cut-out in the drop-ceiling tile. A diameter of the bezel may be at least 9 inches, wherein a length of drop-ceiling tile may be at most 23.75 inches. The luminaire includes an electrical connector configured to interface with a power cable.

Moreover, the light fixture includes multiple fastening members configured to fasten the bezel to a drop-ceiling tile. The multiple fastening members may include a lower set of fastening members and an upper set of fastening members. The lower set of fastening members may be configured to fasten the bezel to a bottom surface of the drop-ceiling. The bezel comprises a set of openings configured to receive the lower set of fastening members. The upper set of fastening members may be configured to be disposed over a top surface of the drop-ceiling. The upper set of fastening members may be configured to mechanically engage with the lower set of fastening members.

In some embodiments, one or more fastening members of the multiple fastening members may include one or more protrusions configured to be lodged into the top surface of the drop-ceiling tile. The one or more protrusions may include one or more wedges. A base of a wedge in the one or more wedges may be disposed adjacent to a face of the fastening member. An apex of the wedge may be disposed distal to the face of the fastening member. Further, one or more slopes of the one or more wedges may be in the form of an arc. For example, the one or more protrusions may include six protrusions, wherein a height of each protrusion is at least 0.22 inches. A surface area of a face of the one or more protrusions may be configured to be juxtaposed with the top surface of the drop-ceiling is at least 0.75 square inches.

Further, the one or more fastening members may be circular nuts. Each circular nut may include a threaded cavity disposed at the center of the circular nut. The one or more protrusions may be disposed over a face of the circular nut. The purpose of the one or more protrusions is to hold the circular nut in place. Without the one or more protrusions, the circular nut may slip against the surface of the drop-ceiling tile. The circular nut may be configured to be disposed on a top surface of the drop-ceiling, wherein the face of the circular nut may be configured to be juxtaposed with the top surface of the drop-ceiling. The threaded cavity may be configured to mechanically engage with a threaded extension of another fastening member of the multiple fastening members, wherein the another fastening member may be configured to fasten the bezel to a bottom surface of the drop-ceiling, wherein the bottom surface is opposite to the top surface. Further, multiple protrusions may include a first set of protrusions disposed around the threaded cavity and a second set of protrusions perimetrically disposed around the circular nut. One or both of the first set of protrusions and the second set of protrusions may be disposed equidistantly. A distance of one or both of the first set of protrusions and the second of protrusions from the center of the circular nut may be configured to provide adequate anti-torque stability in response to the threaded extension mating with the circular nut.

In addition, the light fixture may include a safety cable. A first end of the safety cable may be attachable to the light fixture and a second end of the safety cable may be attachable to a support structure associated with the drop-ceiling.

According to some embodiments, a light fixture configured to be mounted on a drop-ceiling is disclosed. The light fixture includes a luminaire. The luminaire may include a body comprising a cavity and an opening leading to the cavity. Further, the luminaire may include a socket attached to the body, wherein the socket may be configured to receive one or more light sources. Yet further, the luminaire may include an electrical connector configured to interface with a power cable, wherein the electrical connector may be electrically coupled to the socket in order to provide electrical power to the one or more light sources. Further, the luminaire may include a collar plate disposed at a periphery of the opening. The collar plate may be in the form of a bezel. The collar plate may include an upper side, a lower side and an exterior side, wherein the collar plate extends lateral to a longitudinal axis of the body, wherein the collar plate may include multiple openings configured to receive a fastening member. Multiple collar plate fasteners may be configured to fasten the collar plate to the body of the luminaire.

Moreover, the luminaire may include multiple fastening members comprising a set of upper fastening members and a set of lower fastening members. The set of upper fastening members may be configured to fasten the collar plate to a bottom surface of a drop-ceiling tile through the multiple openings. The upper fastening members may be configured to be disposed over the top surface of the drop-ceiling, wherein the upper fastening members may be configured to mechanically engage with the lower set of fastening members. One of both of the upper set of fastening members and the lower set of fastening members may include multiple protrusions configured to be lodged into one or both of the top surface of the drop-ceiling tile and the bottom surface of the drop-ceiling tile.

According to some embodiments, a retrofit kit for facilitating mounting of a recessed light fixture to a drop-ceiling is disclosed. The retrofit kit may include a collar plate comprising an upper side, a lower side, an interior side and an exterior side. The interior side may be configured to be juxtaposed with an exterior surface of a body of the recessed light fixture. The exterior surface may be proximal to a light fixture opening of the recessed light fixture. The collar plate may include a collar plate opening conforming to the light fixture opening, wherein the collar plate further comprises multiple holes, wherein each hole is configured to receive a fastening member configured to fasten the collar plate to a drop-ceiling tile. Further, one or more collar plate fasteners may be configured to fasten the collar plate to the body of the recessed light fixture. Moreover, multiple drop-ceiling fasteners may be configured to fasten the collar plate to the drop-ceiling tile. The multiple drop-ceiling fasteners comprises a set of upper fastening members and a set of lower fastening members, wherein the set of upper fastening members may be configured to fasten the collar plate to a bottom surface of a drop-ceiling tile through the multiple holes. The upper fastening members may be configured to be disposed over the top surface of the drop-ceiling, wherein the upper fastening members are configured to mechanically engage with the lower set of fastening members, wherein the upper set of fastening members comprise multiple protrusions configured to be lodged into the top surface of the drop-ceiling tile.

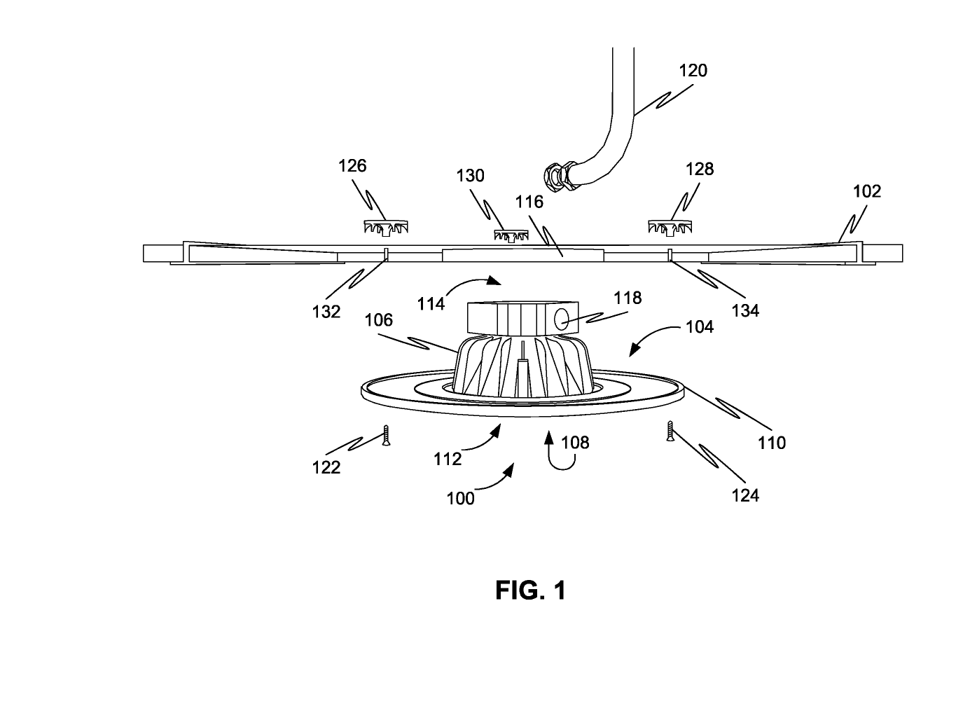

Referring now to figures, FIG. 1 shows a perspective view of a light fixture 100 configured to be mounted on a drop ceiling 102, in accordance with various embodiments disclosed herein. The light fixture 100 may include a luminaire 104. The luminaire 104 may be a can-type lighting system. The drop ceiling 102 may be made of one or more of wood, sheetrock, metal and any other solid material.

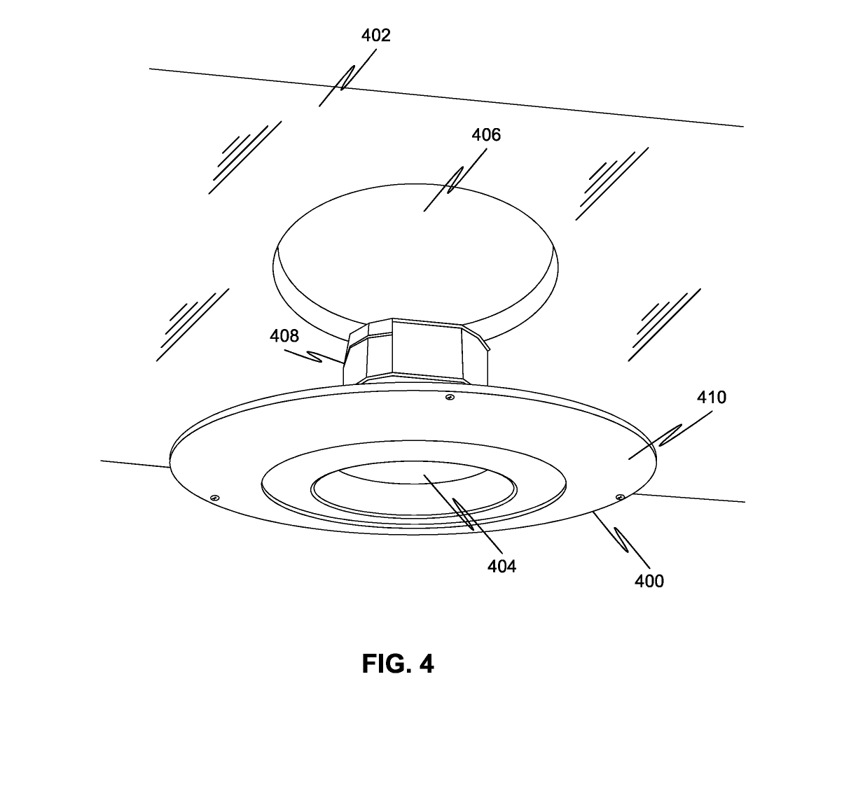

Further, the luminaire 104 may include a body 106 comprising a cavity 108 configured to house one or more light sources. The luminaire 104 may also include one or more sockets (not shown) configured to receive the one or more light sources. Further, the luminaire 104 may include a bezel 110 circumferentially disposed around an opening of the cavity 108. The body 106 may include a proximal portion 112 and a distal portion 114, wherein the bezel 110 may be disposed adjacent to the proximal portion 112, wherein the distal portion 114 may be configured to pass through a cut-out 116 in the drop-ceiling tile in the drop ceiling 102. This is explained in further detail in conjunction with FIGS. 4-7. For example, a diameter of the bezel 110 may be at least 9 inches, wherein a length of drop-ceiling tile is at most 23.75 inches. Further, the luminaire 104 may include an electrical connector 118 configured to interface with a power cable 120.

Moreover, the light fixture 100 may include multiple fastening members 122-130 configured to fasten the bezel 110 to a drop-ceiling tile in the drop ceiling 102.

The multiple fastening members 122-130 may include a lower set of fastening members 122-124 and an upper set of fastening members 126-130. The lower set of fastening members 122-124 may be configured to fasten the bezel 110 to a bottom surface of the drop-ceiling 102. The bezel 110 may include a set of openings (not shown) configured to receive the lower set of fastening members 122-124. Further, the drop-ceiling 102 may include a set of pre-drilled pilot holes 132-134 configured to receive the lower set of fastening members 122-124. For example, the lower set of fastening members 122-124 may be threaded screws. In some embodiments, threaded anchors may also be used such that the threaded anchors engage with the set of pre-drilled pilot holes 132-134 and the lower set of fastening members 122-124. The threaded anchors may seal the set of pre-drilled pilot holes 132-134 properly.

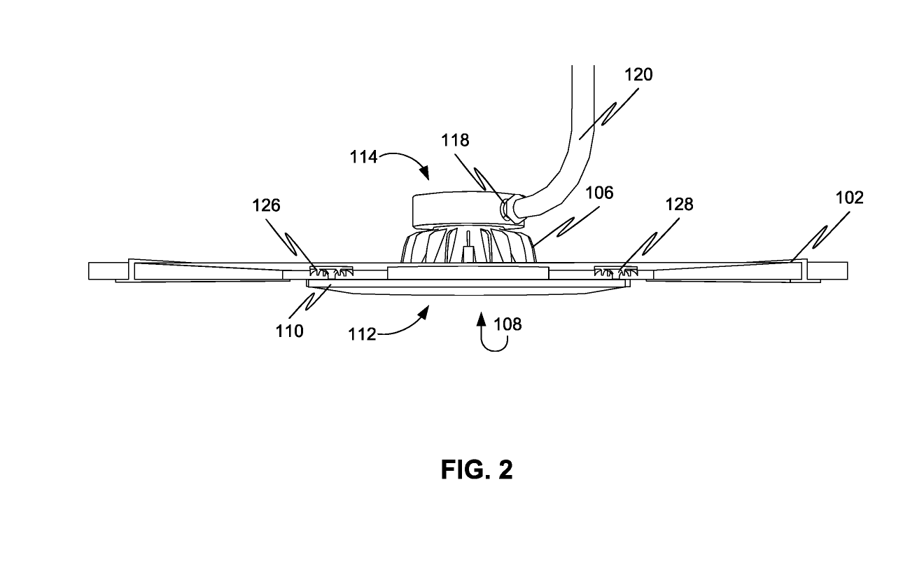

Further, the upper set of fastening members 126-130 may be configured to be disposed over a top surface of the drop-ceiling 102, wherein the upper set of fastening members 126-130 may be configured to mechanically engage with the lower set of fastening members 122-124. FIG. 2 shows a perspective view of the light fixture 100 mounted on the drop ceiling 102.

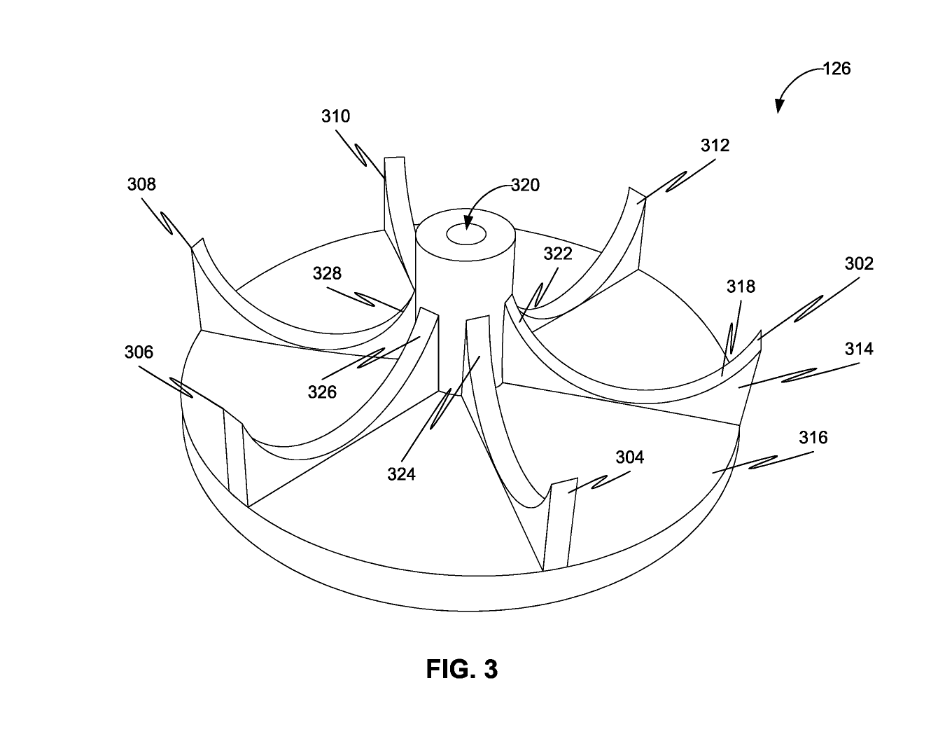

The upper set of fastening members 126-130 may include one or more protrusions configured to be lodged into the top surface of the drop-ceiling 102. FIG. 3 shows a perspective view of the upper fastening member 126, in accordance with some embodiments. The upper fastening member 126 includes six protrusions 302-312 configured to be lodged into the top surface of the drop-ceiling 102. Each protrusion in the protrusions 302-312 may include a wedge, wherein a base of the wedge is disposed adjacent to a face of the upper fastening member 126, wherein an apex of the wedge is disposed distal to the face of the upper fastening member 126. For example, the protrusion 302 includes a wedge 314, wherein a base of the wedge 314 is disposed adjacent to a face 316 of the upper fastening member 126, wherein an apex of the wedge 314 is disposed distal to the face of the upper fastening member 126. Further, a slope 318 of the wedge 314 may be in the form of an arc. For example, a height of each protrusion in the protrusions 302-312 may be at least 0.22 inches. Moreover, a surface area of a face of the protrusion 302 configured to be juxtaposed with the top surface of the drop-ceiling 102 may be at least 0.75 square inches.

Further, the upper fastening member 126 may be a circular nut comprising a threaded cavity 320 disposed at the center of the circular nut. The threaded cavity 320 may be configured to mechanically engage with a threaded extension of the lower fastening member 122. The protrusions 302-312 are perimetrically disposed around the circular nut. Further, multiple protrusions 322-328 may be disposed around the threaded cavity 320.

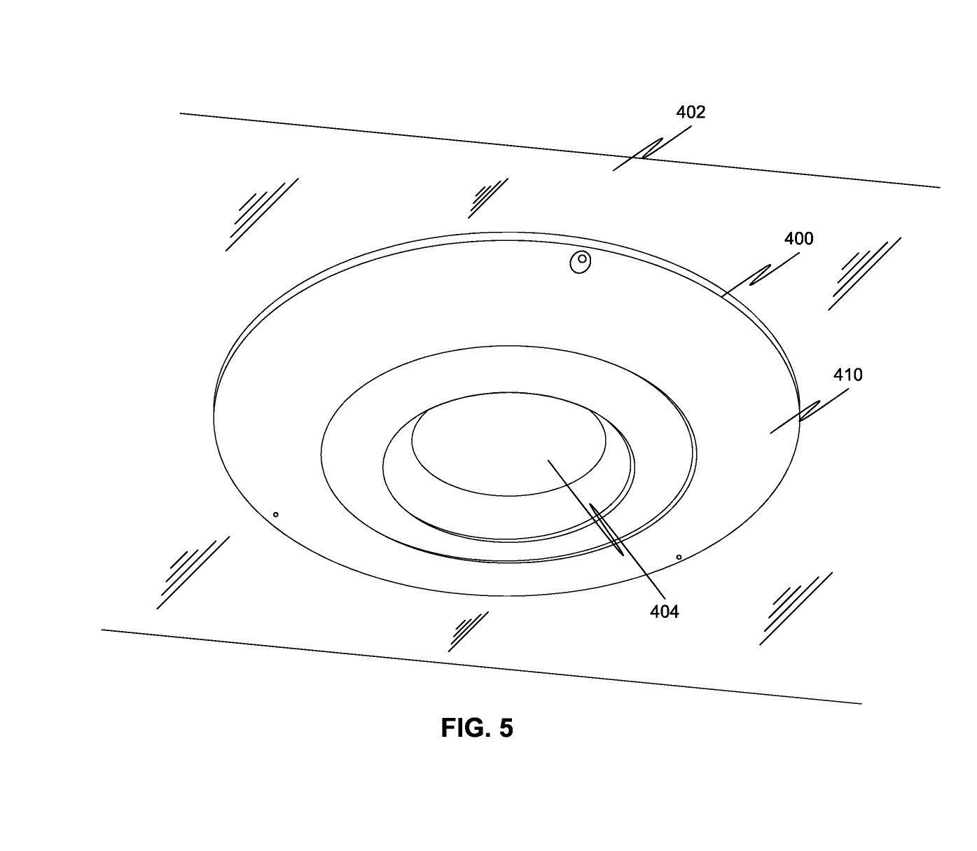

FIG. 4 shows a perspective view of the light fixture 400 before it is installed in a drop-ceiling 402, in accordance with some embodiments. The light fixture 400 may include a cavity 404 configured to house one or more light sources. The drop-ceiling 402 may include a cut-out 406. During installation, a distal portion 408 of the light fixture 400 passes through the cut-out 406 in the drop-ceiling tile 402, as shown in FIG. 5.

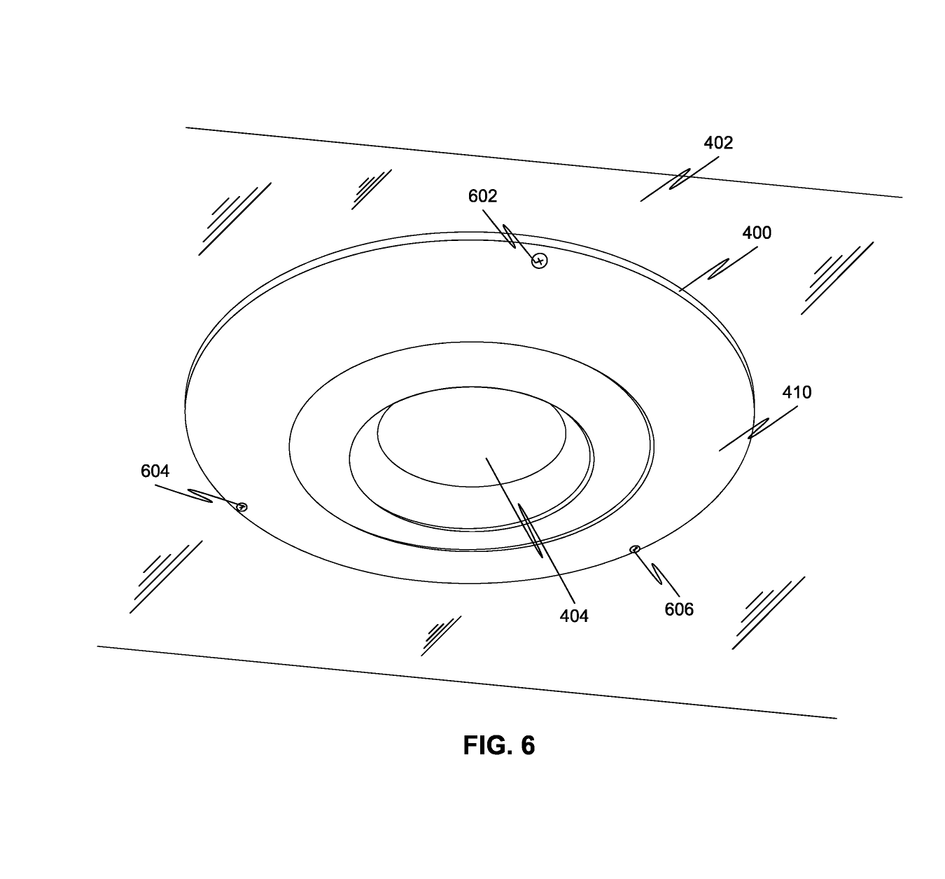

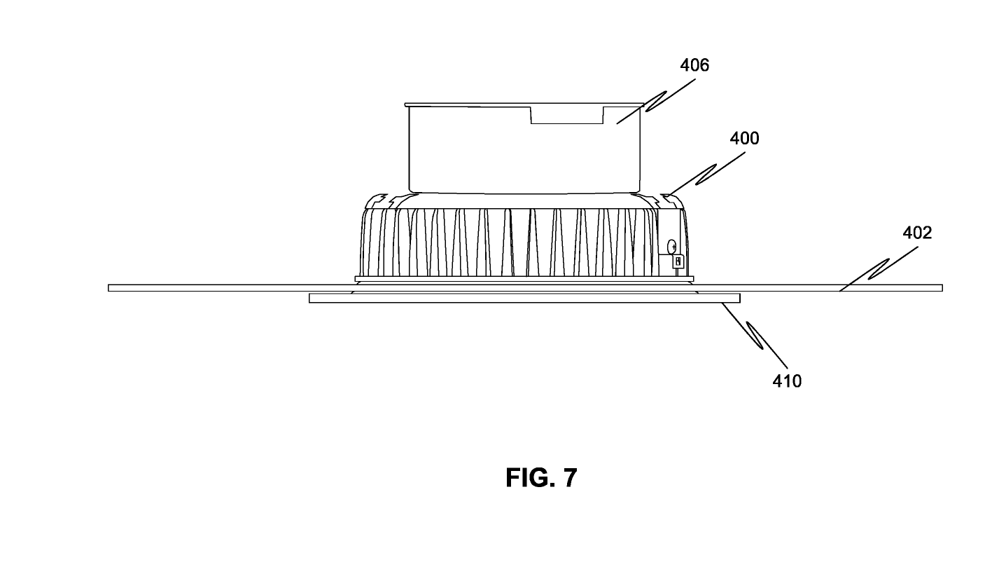

Further, a bezel 410 of the light fixture 400 comes in contact with the drop-ceiling tile 402. Finally, multiple fasteners 602-606 may be used to secure the light fixture 400 with the drop-ceiling 402, as shown in FIG. 6. FIG. 7 shows a side view of the light fixture 400 installed with the drop-ceiling 402.

Although the invention has been explained in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of this invention.

I claim:

1. A light fixture configured to be mounted on a drop ceiling, the light fixture comprising:
a luminaire comprising:
a body comprising a cavity configured to house at least one light source;
a bezel circumferentially disposed around an opening of the cavity; and
an electrical connector configured to interface with a power cable; and
a plurality of fastening members configured to fasten the bezel to a drop-ceiling tile.

2. The light fixture of claim 1, wherein the body comprises a proximal portion and a distal portion, wherein the bezel is disposed adjacent to the proximal portion, wherein the distal portion is configured to pass through a cut-out in the drop-ceiling tile.

3. The light fixture of claim 1, wherein the plurality of fastening members comprises a lower set of fastening members and an upper set of fastening members, wherein the lower set of fastening members is configured to fasten the bezel to a bottom surface of the drop-ceiling, wherein the bezel comprises a set of openings configured to receive the lower set of fastening members, wherein the upper set of fastening members is configured to be disposed over a top surface of the drop-ceiling, wherein the upper set of fastening members is configured to mechanically engage with the lower set of fastening members.

4. The light fixture of claim 1, wherein at least one fastening member of the plurality of fastening members comprises at least one protrusion configured to be lodged into the top surface of the drop-ceiling tile.

5. The light fixture of claim 4, wherein the at least one protrusion comprises at least one wedge, wherein a base of the wedge is disposed adjacent to a face of the at least one fastening member, wherein an apex of the wedge is disposed distal to the face of the at least one fastening member.

6. The light fixture of claim 4, wherein at least one slope of the at least one wedge is in the form of an arc.

7. The light fixture of claim 4, wherein the at least one protrusion comprises six protrusions, wherein a height of each protrusion is at least 0.22 inches.

8. The light fixture of claim 4, wherein a surface area of a face of the at least one protrusion configured to be juxtaposed with the top surface of the drop-ceiling is at least 0.75 square inches.

9. The light fixture of claim 4, wherein the at least one fastening member is a circular nut comprising a threaded cavity disposed at the center of the circular nut, wherein the at least one protrusion comprises a plurality of protrusions disposed over a face of the circular nut, wherein the circular nut is configured to be disposed on an top surface of the drop-ceiling, wherein the face of the circular nut is configured to be juxtaposed with the top surface of the drop-ceiling, wherein the threaded cavity is configured to mechanically engage with a threaded extension of another fastening member of the plurality of fastening members, wherein the another fastening member is configured to fasten the bezel to a bottom surface of the drop-ceiling, wherein the bottom surface is opposite to the top surface.

10. The light fixture of claim 9, wherein the plurality of protrusions comprises a first set of protrusions disposed around the threaded cavity and a second set of protrusions perimetrically disposed around the circular nut.

11. The light fixture of claim 10, wherein at least one of the first set of protrusions and the second set of protrusions is disposed equidistantly.

12. The light fixture of claim 10, wherein a distance of at least one of the first set of protrusions and the second of protrusions from the center of the circular nut is configured to provide adequate anti-torque stability in response to the threaded extension mating with the circular nut.

13. The light fixture of claim 1, wherein the luminaire comprises a socket configured to receive the at least one light source.

14. The light fixture of claim 1 further comprising a safety cable, wherein a first end of the safety cable is attachable to the light fixture and a second end of the safety cable is attachable to a support structure associated with the drop-ceiling.

15. The light fixture of claim 1, wherein the luminaire is a can-type lighting system.

16. The light fixture of claim 1, wherein a diameter of the bezel is at least 9 inches, wherein a length of drop-ceiling tile is at most 23.75 inches.

17. A light fixture configured to be mounted on a drop-ceiling, the light fixture comprising:
a luminaire comprising:
a body comprising a cavity and an opening leading to the cavity;
a socket attached to the body, wherein the socket is configured to receive at least one light source;
an electrical connector configured to interface with a power cable, wherein the electrical connector is electrically coupled to the socket in order to provide electrical power to the at least one light source;
a collar plate disposed at a periphery of the opening, wherein the collar plate comprises an upper side, a lower side and an exterior side, wherein the collar plate extends lateral to a longitudinal axis of the body, wherein the collar plate comprises a plurality of openings configured to receive a fastening member; and
a plurality of fastening members comprising a set of upper fastening members and a set of lower fastening members, wherein the set of upper fastening members are configured to fasten the collar plate to a bottom surface of a drop-ceiling tile through the plurality of openings, wherein the upper fastening members are configured to be disposed over the top surface of the drop-ceiling, wherein the upper fastening members are configured to mechanically engage with the lower set of fastening members, wherein at least one of the upper set of fastening members and the lower set of fastening members comprise a plurality of protrusions configured to be lodged into at least one of the top surface of the drop-ceiling tile and the bottom surface of the drop-ceiling tile.

18. The light fixture of claim 17, wherein the collar plate is in the form of a bezel.

19. The light fixture of claim 17 further comprising a plurality of collar plate fasteners configured to fasten the collar plate to the body of the luminaire.

20. A retrofit kit for facilitating mounting of a recessed light fixture to a drop-ceiling, the retrofit kit comprising:
a collar plate comprising an upper side, a lower side, an interior side and an exterior side, wherein the interior side is configured to be juxtaposed with an exterior surface of a body of the recessed light fixture, wherein the exterior surface is proximal to a light fixture opening of the recessed light fixture, wherein the collar plate comprises a collar plate opening conforming to the light fixture opening, wherein the collar plate further comprises a plurality of holes, wherein each hole is configured to receive a fastening member configured to fasten the collar plate to a drop-ceiling tile;
at least one collar plate fastener configured to fasten the collar plate to the body of the recessed light fixture; and
a plurality of drop-ceiling fasteners configured to fasten the collar plate to the drop-ceiling tile, wherein the plurality of drop-ceiling fasteners comprises a set of upper fastening members and a set of lower fastening members, wherein the set of upper fastening members are configured to fasten the collar plate to a bottom surface of a drop-ceiling tile through the plurality of holes, wherein the upper fastening members are configured to be disposed over the top surface of the drop-ceiling, wherein the upper fastening members are configured to mechanically engage with the lower set of fastening members, wherein the upper set of fastening members comprise a plurality of protrusions configured to be lodged into the top surface of the drop-ceiling tile.
